(19) United States
(12) Patent Application Publication
(10) Pub. No.: US 2026/0261339 A1
(43) Pub. Date: Sep. 3, 2026

(54) NETWORK DEVICE AND DATA INTERCHANGE METHOD

(71) Applicant: NIPPON TELEGRAPH AND TELEPHONE CORPORATION, Tokyo (JP)

(72) Inventors: Hiroshi O, Musashino-shi, Tokyo (JP); Kota ASAKA, Musashino-shi, Tokyo (JP); Tatsuya SHIMADA, Musashino-shi, Tokyo (JP)

(73) Assignee: NIPPON TELEGRAPH AND TELEPHONE CORPORATION, Tokyo (JP)

(21) Appl. No.: 18/718,418

(22) PCT Filed: Dec. 21, 2021
(86) PCT No.: PCT/JP2021/047381

§ 371 Date: Jun. 10, 2024

(51) Int. Cl. H04B 10/073

(52) U.S. Cl. CPC H04B 10/073

(57) ABSTRACT

A communication network that transmits user data has a network device. The network device includes an acquisition unit, an identification unit, and a transmitting unit. The acquisition unit acquires inter-network-device data which is data superimposed on user data in an out-of-band method and exchanged between network devices included in the communication network from data obtained by splitting or copying data transmitted through a transmission line of the communication network. The identification unit outputs the acquired data to a processing unit that performs predetermined processing when a destination of the acquired data which is the inter-network-device data acquired by the acquisition unit is a host device and discards the acquired data when the destination is not the host device. The transmitting unit superimposes inter-network-device data addressed from the host device to another network device on user data transmitted through the transmission line in an out-of-band method.

### TECHNICAL FIELD

The present invention relates to network devices and data exchange methods.

### BACKGROUND ART

A communication network employs a system having control and communication functions. An example of such a system is an L3 (Layer 3) router with a routing table and a switch function. In some cases, the control and communication functions are separated into different devices.

FIG. 25 is a diagram showing a configuration example of a conventional communication system. In a communication system, communication devices #1 and #2 constitute a communication network that transmits and receives user data. The communication device has an information measurement unit having a function of measuring information and an information exchanging unit for exchanging the measured information with other devices. A communication device collects necessary information by transmitting and receiving information measurement signals and information responses to and from other communication devices. For these transmissions and receptions, for example, a routing protocol in an L3 router such as a routing information protocol (RIP) is used (for example, see NPL 1). As shown in FIG. 26, in the prior art, user data U and inter-network-device data V in which information measurement signals or information responses are set are multiplexed and transmitted through the same communication path by time-division multiplexing (in-band).

As shown in FIG. 25, a communication network may have a monitoring control device that uses quality measurement results in the communication devices. The information collection unit of the monitoring control device collects the quality measurement results measured by the quality measurement unit of the communication device and transmitted from the information reporting unit. The function of the information collection unit is implemented by conventional remote quality measurement methods such as a simple network management protocol (SNMP) and Telemetry (see, for example, NPL 2). Even in such a case, as shown in FIG. 26, in the prior art, user data U and inter-network-device data V in which quality measurement results are set are multiplexed and transmitted through the same communication path by time-division multiplexing.

Note that the network configuration shown in FIG. 25 is only an example, and other configurations are possible. For example, communication devices can be connected in a ring structure or a tree structure. In some cases, the information measurement unit and the information exchanging unit are provided in separate and different devices. In some cases, the monitoring control device and the communication device are integrated.

### CITATION LIST

### Non Patent Literature

[NPL 1] RFC1058, “Routing Information Protocol”, [online], 1988, Internet
<URL:https://datatracker.ietf.org/doc/html/rfc1058>
[NPL 2] RFC1157, “A Simple Network Management Protocol (SNMP)”, [online], 1990, Internet
<URL:https://datatracker.ietf.org/doc/html/rfc1157>

### SUMMARY OF INVENTION

### Technical Problem

As described above, inter-network-device data and user data are multiplexed and transmitted by time-division multiplexing. Therefore, in-band communication must be established in advance to transmit information measurement signals and information responses or quality measurement results.

In addition, in order to identify and separate inter-network-device data and user data, it is necessary to unify network protocols such as an Internet protocol (IP) and Ethernet (registered trademark) and perform determination using a destination and an identifier set in the data. Therefore, when the user data is a signal such as Radio over Fiber (RoF), the information measurement signals and the information responses cannot be multiplexed as they are. Furthermore, even for user data that can be multiplexed and demultiplexed by time-division multiplexing, network quality is affected by the insertion of information measurement signals and information responses. For example, delay and jitter occurs, and the band used for user data is reduced.

In view of the above circumstances, an object of the present invention is to provide a network device and a data exchange method capable of transmitting and receiving information between devices constituting a network while reducing the impact on the quality of user data regardless of the protocol of user data.

### Solution to Problem

One aspect of the present invention provides a network device of a communication network that transmits user data, the network device including: an acquisition unit that acquires inter-network-device data which is data superimposed on user data in an out-of-band method and exchanged between network devices included in the communication network from data obtained by splitting or copying data transmitted through a transmission line of the communication network; an identification unit that outputs the acquired data to a processing unit that performs predetermined processing when a destination of the acquired data which is the inter-network-device data acquired by the acquisition unit is a host device and discards the acquired data when the destination is not the host device; and a transmitting unit that superimposes inter-network-device data addressed from the host device to another network device on user data transmitted through the transmission line in an out-of-band method.

One aspect of the present invention provides a data exchange method performed by a network device of a communication network that transmits user data, the method including: an acquisition step of acquiring inter-network-device data which is data superimposed on user data in an out-of-band method and exchanged between network devices included in the communication network from data obtained by splitting or copying data transmitted through a transmission line of the communication network; an identification step of outputting the acquired data to a processing unit that performs predetermined processing when a destination of the acquired data which is the inter-network-device data acquired in the acquisition step is a host device and discarding the acquired data when the destination is not the host device; and a transmitting unit of superimposing inter-network-device data addressed from the host device to another network device on user data transmitted through the transmission line in an out-of-band method.

### Advantageous Effects of Invention

According to the present invention, it is possible to transmit and receive information between devices constituting a network while reducing the impact on the quality of user data regardless of the protocol of user data.

### BRIEF DESCRIPTION OF DRAWINGS

FIG. 1 is a diagram showing data transmission according to an embodiment of the present invention.

FIG. 2 is a diagram showing the data transmission according to the embodiment.

FIG. 3 is a diagram showing the data transmission according to the embodiment.

FIG. 4 is a block diagram of a communication system according to a first embodiment.

FIG. 5 is a block diagram of a communication device according

FIG. 6 is a flowchart showing network signal transmission processing of the communication device according to the embodiment.

FIG. 7 is a flowchart showing network signal reception processing of the communication device according to the embodiment.

FIG. 8 is a block diagram of the communication system according to the embodiment.

FIG. 10 is a block diagram of a communication system according to a second embodiment.

FIG. 10 is a block diagram of the monitoring control device and communication device according to the embodiment.

FIG. 11 is a block diagram of a communication device according to the embodiment.

FIG. 12 is a flowchart showing network signal transmission/reception processing of the monitoring control device according to the embodiment.

FIG. 13 is a flowchart showing network signal transmission processing of the communication device according to the embodiment.

FIG. 14 is a flowchart showing network signal reception processing of the communication device according to the embodiment.

FIG. 15 is a block diagram of the communication system according to the embodiment.

FIG. 16 is a block diagram of a separation device according to the embodiment.

FIG. 17 is a flowchart showing network signal transmission/reception processing of the separation device according to the embodiment.

FIG. 18 is a block diagram of the communication system according to the embodiment.

FIG. 19 is a block diagram of a monitoring control device and a distribution device according to the embodiment.

FIG. 20 is a flowchart showing network signal transmission/reception processing of the communication system

FIG. 21 is a block diagram of a communication system according to a third embodiment.

FIG. 22 is a diagram showing a configuration related to an optical switch function of the communication device according to the embodiment.

FIG. 23 is a diagram showing the example of the quality information according to the embodiment.

FIG. 24 is a diagram showing a hardware configuration of the communication device according to the first embodiment.

FIG. 25 is a diagram showing a configuration of a conventional communication system.

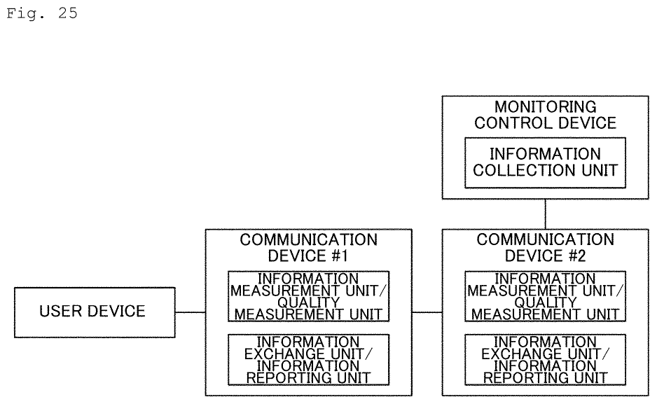

FIG. 26 is a diagram showing conventional data transmission.

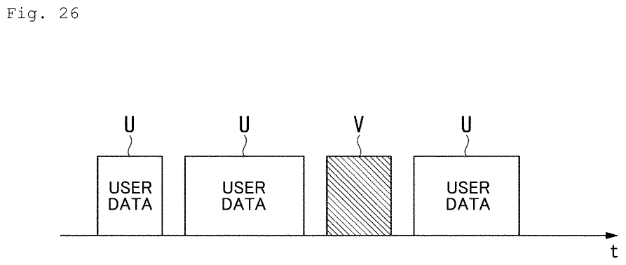

### DESCRIPTION OF EMBODIMENTS

Hereinafter, embodiments of the present invention will be described in detail with reference to the drawings. In the present embodiment, inter-network-device data, which is data exchanged between network devices constituting a communication network that transmits user data, is superimposed on user data, which is a main signal transmitted by the communication network, in an out-of-band method. The out-of-band method is, for example, an auxiliary management and control channel (AMCC) technology specified in NG-PON2. AMCC is a control method using a protocol-free control signal that can be superimposed on the main signal. AMCC signals are transmitted by superimposing a low-speed carrier wave on the main signal and convey information by intensity modulation. The AMCC signals superimposed in this way can be separated from the main signal. AMCC is described, for example, in Reference 1 “G. 989.3, ”40-Gigabit-capable passive optical networks (NG-PON2): Transmission convergence layer specification“, ITU-T, 2021”.

A signal for transmitting and receiving inter-network-device data between network devices is hereinafter referred to as a network signal. Network devices include a communication device that transmits user data, a monitoring control device that monitors and controls a communication network, and the like. Examples of network signals include information measurement signals and information responses transmitted and received between communication devices, report instructions transmitted from the monitoring control device to the communication device, and quality information reports transmitted from the communication device to the monitoring control device. The information measurement signal is a signal for measuring information. An information response is a signal for notifying the measured information. The report instruction is a signal instructing to report network quality measurement results. The quality information report is a signal for notifying the network quality measurement results. Note that network signals are not limited to these examples. In the following description, a case where a communication network for transmitting user data is a network for performing optical communication will be described as an example, but the communication network may be a network for performing communication other than optical communication such as radio communication.

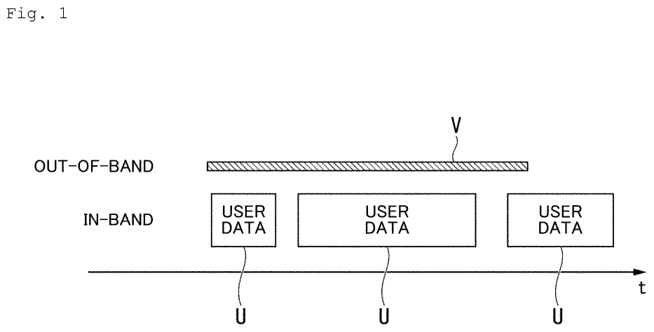

FIGS. 1 to 3 are diagrams showing data transmission using the out-of-band method in the communication system of the present embodiment. User data U is U-Plane (transport plane) data. Inter-network-device data V is data in which a network signal is set. The information measurement signals and the information responses are C-Plane (control plane) network signals transmitted and received between communication devices. The report instruction and the quality information report are M-Plane (management plane) network signals transmitted and received between the communication device and the monitoring control device.

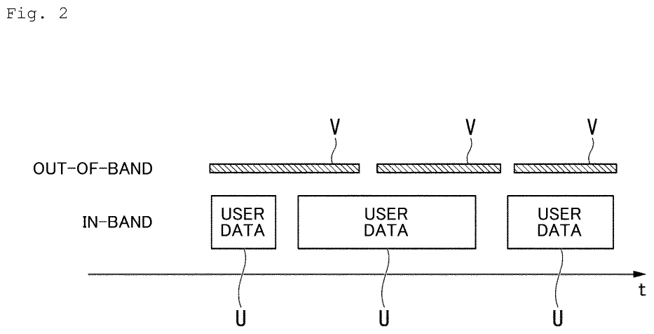

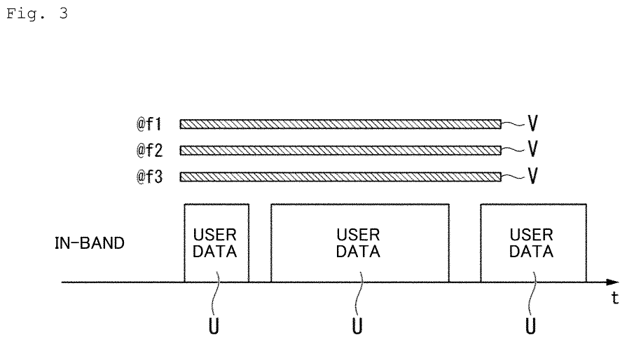

In FIG. 1, the inter-network-device data V from one network device is superimposed on user data U in an out-of-band method. In FIG. 2, the inter-network-device data V from each of a plurality of network devices is superimposed on user data U in a time-division manner in an out-of-band method. In FIG. 3, the pieces of inter-network-device data V from a plurality of network devices are superimposed on user data U using channels of different wavelengths @f1, @f2, and @f3. By combining FIG. 2 and FIG. 3, the inter-network-device data V may be superimposed on user data U in an out-of-band method on each channel in a time division manner. The time to be used in the case of superimposition using time division and the channel to be used in the case of superimposition using multiple channels may be specified by the monitoring control device, and each communication device may monitor the use state to determine vacant times or channels.

The AMCC signals of the prior art are used for control between transceivers. In the present embodiment, AMCC signals are used not for control purposes between transceivers, but for signals between communication devices and signals between the communication device and the monitoring control device. The communication system of the present embodiment superimposes and transmits network signals in an out-of-band method to a communication network that transmits user data. Therefore, it is possible to transmit and receive information measurement signals and information responses between communication devices and to notify the network quality measurement result from the communication device to the monitoring control device in a protocol-free manner without affecting the quality of user data. In addition, by using the out-of-band method, network signals can be transmitted and received between network signal devices even when in-band communication for transmitting and receiving user data is not established. Furthermore, even when a plurality of the communication devices exist, it is possible to transmit and receive information measurement signals and information responses between the communication devices and to notify the network quality measurement result from the communication device to the monitoring control device using an out-of-band method. The present embodiment will be described in detail below.

### First Embodiment

In the present embodiment, information measurement signals and information responses are transmitted and received between communication devices.

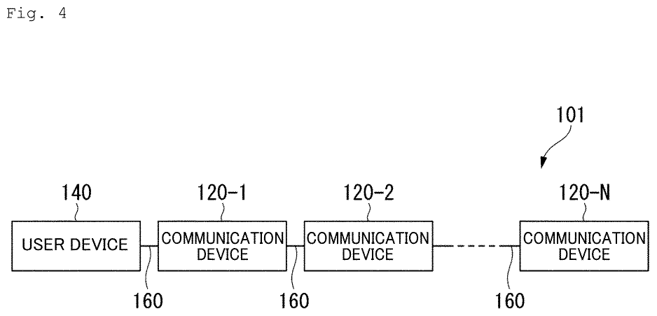

FIG. 4 is a diagram showing a configuration example of a communication system 101 according to the first embodiment. The communication system 101 has a communication network composed of N communication devices 120 connected in cascade. The N communication devices 120 are respectively described as the communication devices 120-1 to 120-N. A user device 140 may be connected to the communication device 120. The communication device 120 is connected to another adjacent communication device 120 by an optical transmission line 160. The direction from the communication device 120-1 to the communication device 120-N is an upper direction, and the direction from the communication device 120-N to the communication device 120-1 is a lower direction. Although the communication devices 120 are connected in cascade in FIG. 4, different topologies may be used.

The communication device 120 relays user data. The communication device 120 transmits and receives network signals to and from another communication device 120 in an out-of-band method using a wavelength different from the wavelength of optical signals for transmitting and receiving user data. A network signal includes destination information, transmission source information and data type information. The destination information indicates the network device to which the network signal is transmitted. The transmission source information indicates the network signal device from which the network signal originated. The data type information is an identifier representing the type of data transmitted as a network signal.

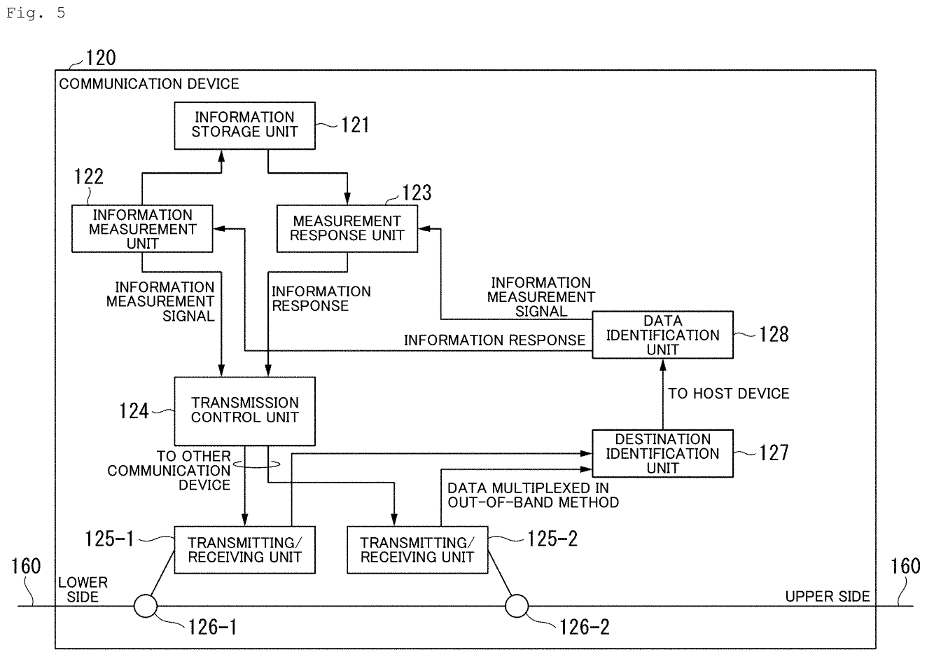

FIG. 5 is a block diagram showing a configuration example of the communication device 120. In FIG. 5, only functional blocks related to the present embodiment are extracted and shown. The communication device 120 includes an information storage unit 121, an information measurement unit 122, a measurement response unit 123, a transmission control unit 124, a transmitting/receiving unit 125-1, a transmitting/receiving unit 125-2, a coupler 126-1, a coupler 126-2, a destination identification unit 127, and a data identification unit 128. The couplers 126-1 and 126-2 are referred to collectively as the coupler 126 unless any one of them is specified. The transmitting/receiving unit 125-1 and the transmitting/receiving unit 125-2 are collectively referred to as the transmitting/receiving unit 125 unless any One of them is specified.

The information storage unit 121 stores information. The information stored by the information storage unit 121 is, for example, routing information between adjacent communication devices 120 and network quality information such as network latency, but is not limited to these.

The information measurement unit 122 performs information measurement on other communication devices 120 to learn or update information held by the host device. The information measurement unit 122 generates an information measurement signal to be transmitted to other communication device 120. The information measurement signal includes destination information indicating another communication device 120 as a destination, transmission source information indicating the host device, and data type information indicating the information measurement. In the destination information, a unicast destination using the address of the communication device 120 may be set, or a multicast or broadcast destination including a destination communication device 120 may be set. The information measurement unit 122 outputs the generated information measurement signal to the transmission control unit 124. The information measurement unit 122 also receives an information response returned from other communication device 120 in response to the information measurement signal transmitted by the host device. The information measurement unit 122 learns or updates information stored in the information storage unit 121 based on the information set in the received information response.

The measurement response unit 123 receives information measurement signals from other communication devices 120. The measurement response unit 123 reads information corresponding to the information measurement signal from the information storage unit 121. The measurement response unit 123 generates an information response in which the read information, the destination information indicating the communication device 120 to which the information measurement signal is transmitted, the transmission source information indicating the host device, and the data type information indicating the information response. The measurement response unit 123 outputs the generated information response to the transmission control unit 124. The information response is transmitted in the direction in which the information measurement signal was received.

The transmission control unit 124 controls the transmitting/receiving unit 125 to transmit network signals such as the information measurement signal output from the information measurement unit 122 and the information response output from the measurement response unit 123 in an out-of-band method. That is, the transmission control unit 124 determines the transmission timing and frequency when transmitting network signals in the out-of-band method, and instructs the transmitting/receiving unit 125. Note that the transmission control unit 124 can transmit network signals in either direction, the upper side or the lower side, based on the determination of the information measurement unit 122 and the measurement response unit 123. The transmission control unit 124 outputs the network signal addressed to the communication device 120 lower than the host device to the transmitting/receiving unit 125-1, and outputs the network signal addressed to the communication device 120 higher than the host device to the transmitting/receiving unit 125-2.

The transmitting/receiving unit 125 is, for example, an optical transceiver (TRx). The transmitting/receiving unit 125 receives a network signal and an instruction on the transmission timing and wavelength of the network signal from the transmission control unit 124. The transmitting/receiving unit 125 converts the network signal from an electrical signal to an out-of-band optical signal of the instructed wavelength. The transmitting/receiving unit 125-i (i=1, 2) outputs the network signal converted into the optical signal to the coupler 126-i at the instructed transmission timing. Further, the transmitting/receiving unit 125-i receives the light split by the coupler 126-i, separates the network signal transmitted in the out-of-band method from the received optical signal, and converts it into an electrical signal. The transmitting/receiving unit 125-i outputs the network signal converted into an electrical signal to the destination identification unit 127.

The coupler 126-1 is provided on the optical transmission line 160 on the lower side, and the coupler 126-2 is provided on the optical transmission line 160 on the upper side. The coupler 126-1 splits the light transmitted through the optical transmission line 160 from the lower side to the upper side, and outputs the split light to the transmitting/receiving unit 125-1. Further, the coupler 126-1 couples the optical signal output from the transmitting/receiving unit 125-1 to the lower side of the optical transmission line 160. The coupler 126-2 splits the light transmitted through the optical transmission line 160 from the upper side to the lower side, and outputs the split optical signal to the transmitting/receiving unit 125-2. Further, the coupler 126-2 couples the optical signal output from the transmitting/receiving unit 125-2 to the upper side of the optical transmission line 160.

An optical filter may be provided between the coupler 126-i and the transmitting/receiving unit 125-i. The optical filter removes signals in unwanted frequency bands. Further, the communication device 120 may use an in-line modulator instead of the coupler 126-i and the transmitting/receiving unit 125-i.

The destination identification unit 127 reads destination information set in the network signal. If the destination information indicates a unicast address of the host device, or multicast or broadcast including the host device, the destination identification unit 127 determines that the signal is addressed to the host device. The destination identification unit 127 outputs the network signal addressed to the host device to the data identification unit 128. The destination identification unit 127 discards the received network signal when it determines that the received signal is not addressed to the host device based on the destination information.

The data identification unit 128 reads data type information set in the network signal. The data identification unit 128 outputs an information measurement signal, which is the received network signal, to the measurement response unit 123 when the data type information indicates information measurement. The data identification unit 128 outputs an information response, which is the received network signal, to the information measurement unit 122 when the data type information indicates an information response.

The information measurement signal and the information response may be transmitted and received between the communication device 120 and the user device 140 or between the user devices 140. In this case, the user device 140 performs the same processing as the communication device 120 in FIG. 5 described above. Further, the transmitting/receiving unit 125 of the user device 140 transmits and receives an in-band optical signal in which user data is set.

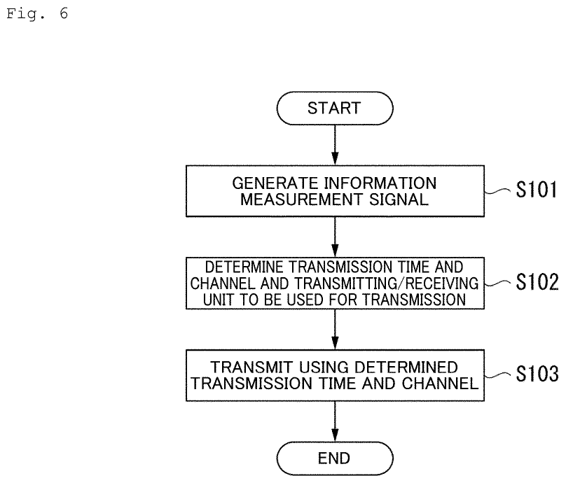

FIG. 6 is a flowchart showing network signal transmission processing in the communication device 120. The information measurement unit 122 generates an information measurement signal addressed to another communication device 120, and outputs the generated information measurement signal to the transmission control unit 124 (step S101). The transmission control unit 124 determines the transmission time of the information measurement signal and the channel and the transmitting/receiving unit 125 to be used for transmission (step S102).

For example, the transmission control unit 124 determines the transmission time and channel when transmitting the network signal in the out-of-band method, based on the transmission control information. The transmission control information is, for example, information with which it is possible to determine the transmission time and the channel to be used in correspondence with one or a combination of the source device and the destination device. If all communication devices 120 use the same wavelength for network signal transmission, channel determination need not be performed. The transmission control information may be notified in advance from a higher-layer device, or may be set in advance uniquely to the device.

Alternatively, the transmission control unit 124 may monitor the communication state of out-of-band data and autonomously determine the transmission time and the channel to be used without using the transmission control information. The communication state of out-of-band data is obtained based on network signals separated by the transmitting/receiving unit 125.

Furthermore, when the destination information indicates unicast addressed to another communication device 120, the transmission control unit 124 determines to which of the transmitting/receiving unit 125-1 and the transmitting/receiving unit 125-2 the network signal is to be output. That is, the transmission control unit 124 determines to output signals to the transmitting/receiving unit 125-1 when the other communication device 120 as the destination is lower than the host device and determines to output signals to the transmitting/receiving unit 125-2 when the other communication device 120 as the destination is higher than the host device. The transmission control unit 124 determines the routing destination indicating whether the other communication device 120 as the destination is lower of higher than the host device, for example, based on the routing information stored in the information storage unit 121 or set in the transmission control information. When the destination information indicates a multicast address, the transmission control unit 124 determines the output destination of the network signal to be one or both of the transmitting/receiving unit 125-1 and transmitting/receiving unit 125-2 based on the multicast address. Further, when the destination information indicates broadcast, the transmission control unit 124 determines both transmitting/receiving units 125-1 and 125-2 as the output destination.

The transmission control unit 124 outputs the information measurement signal to the transmitting/receiving unit 125-i determined as the output destination, and further instructs the determined transmission time and channel. The transmitting/receiving unit 125-i converts the information measurement signal output by the transmission control unit 124 from an electrical signal to an optical signal having a wavelength used for the instructed channel. The transmitting/receiving unit 125-i outputs the information measurement signal converted into the optical signal to the coupler 126-i at the instructed transmission time. The coupler 126-i couples the information measurement signal output from the transmitting/receiving unit 125-i to the optical transmission line 160 (step S103).

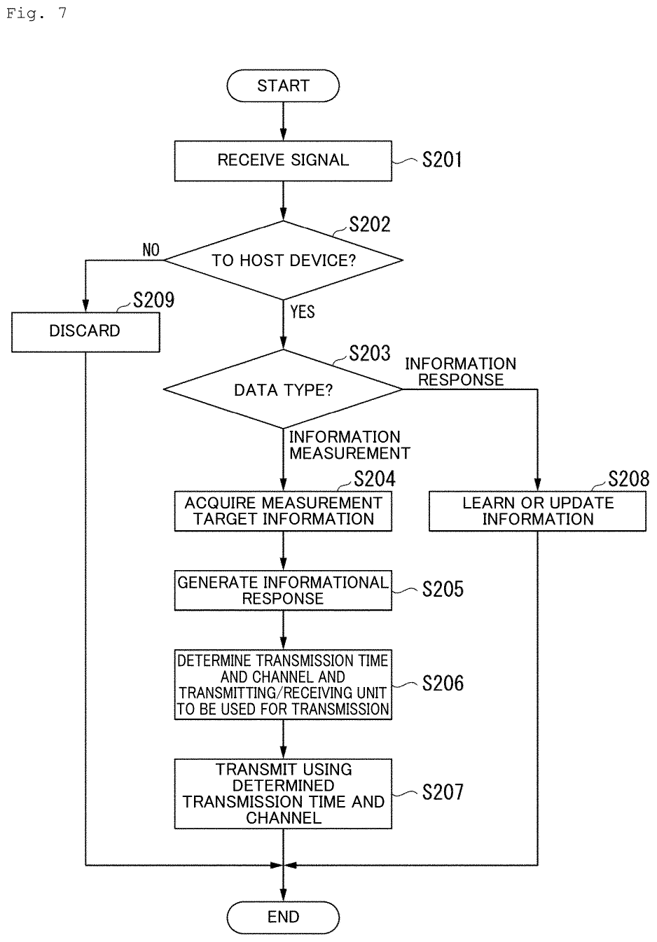

FIG. 7 is a flowchart showing network signal reception processing in the communication device 120. The coupler 126-1 and the coupler 126-2 split the optical signal transmitted through the optical transmission line 160. The coupler 126-i outputs the split optical signal to the transmitting/receiving unit 125-i. The transmitting/receiving unit 125-i separates the network signal transmitted in the out-of-band method from the optical signal split by the coupler 126-i and converts it into an electrical signal. The transmitting/receiving unit 125-i outputs the network signal converted into an electrical signal to the destination identification unit 127 (step S201).

The destination identification unit 127 reads destination information set in the network signal. The destination identification unit 127 determines whether the destination information indicates the host device (step S202). If the destination information indicates a unicast address of the host device, multicast of the host device, or broadcast, the destination identification unit 127 determines that the destination is the host device (step S202: YES), and outputs the network signal to the data identification unit 128.

The data identification unit 128 identifies data based on the data type information set in the network signal (step S203). The data identification unit 128 outputs an information measurement signal, which is the received network signal, to the measurement response unit 123 when the data type information indicates information measurement.

The measurement response unit 123 reads the information of the measurement target corresponding to the information measurement signal from the information storage unit 121 (step S204). The measurement response unit 123 generates an information response in which the read information, destination information indicating communication device 120 as the source of the information measurement signal, transmission information indicating the host device, and data type information indicating the information response are set (step S205). The measurement response unit 123 outputs the generated information response to the transmission control unit 124.

The transmission control unit 124 determines the transmission time of the information response, the channel and the transmitting/receiving unit 125 to be used for transmission, by the same processing as in step S102 of FIG. 6 (step $206). Note that the transmission control unit 124 may select the transmitting/receiving unit 125-i that has received the information The transmission control unit 124 outputs an information response to the determined transmitting/receiving unit 125-i, and further instructs the determined transmission time and channel. The transmitting/receiving unit 125-i converts the information response from an electrical signal to an optical signal of the wavelength used for the instructed channel by the same processing as step S103 in FIG. 6 and outputs the optical signal to the coupler 126-i at the instructed transmission time. The coupler 126-i couples the information response to the optical transmission line 160 (step S207).

On the other hand, in step S203 , when the data type information indicates an information response, the data identification unit 128 determines that the received network signal is an information response returned in response to the information measurement signal transmitted by the host device. The data identification unit 128 outputs the information response to the information measurement unit 122. The information measurement unit 122 learns or updates the information stored in the information storage unit 121 based on the information set in the received information response (step S208).

Further, in step S202, when the destination identification unit 127 determines that the signal is not addressed to the host device (step S202: NO), the destination identification unit 127 discards the received network signal (step S209).

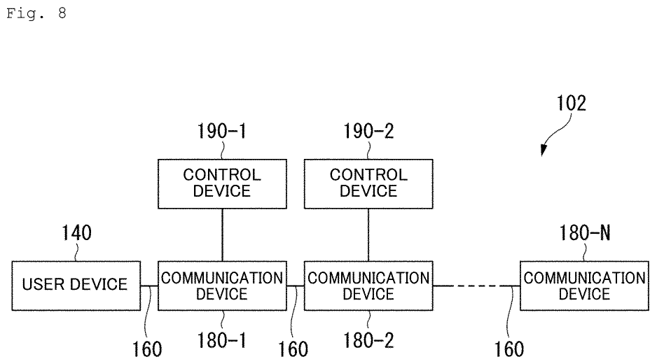

Note that some of the functions of the communication device 120 may be provided by another device. FIG. 8 is a diagram showing a configuration example of the communication system 102. The communication system 102 has N communication devices 180 connected in cascade. In FIG. 8, the N communication devices 180 are described as the communication devices 180-1 to 180-N, respectively. Some communication devices 180 are connected to the control device 190. In FIG. 8, the control device 190 connected to the communication device 180-n is described as the control device 190-n. The communication device 180 not connected to the control device 190 has the same configuration as the communication device 120 shown in FIG. 5.

The communication device 180 connected to the control device 190 has some functions of the communication device 120 shown in FIG. 5, and the control device 190 has other functions of the communication device 120. Except that communication device 180 has the coupler 126, it can be determined arbitrarily which functional units of the communication device 120, each of the communication device 180 and the control device 190 will have. For example, the communication device 180 may include the information storage unit 121, the information measurement unit 122, the measurement response unit 123, the transmitting/receiving unit 125, and the coupler 126, and the control device 190 may include the transmission control unit 124, the destination identification unit 127 and the data identification unit 128. Further, the communication device 180 may include the information storage unit 121, the information measurement unit 122, the measurement response unit 123, the transmitting/receiving unit 125, the coupler 126, and the data identification unit 128, and the control device 190 may include the transmission control unit 124 and the destination identification unit 127. The communication device 180 and the control device 190 may implement the same functional unit of the communication device 120.

According to the present embodiment, since the information measurement signal and the information response are transmitted and received between the communication devices in the out-of-band method, it is possible to transmit these pieces of information even when the in-band communication is not established.

### Second Embodiment

In the present embodiment, the network signal between the communication device and the monitoring control device is superimposed on the user data and transmitted in the out-of-band method.

FIG. 9 is a diagram showing a configuration example of a communication system 201 according to the second embodiment. The communication system 201 has a communication network composed of a monitoring control device 210 and N communication devices 220 connected in cascade.

The monitoring control device 210 manages and controls the communication network. The monitoring control device 210 is connected to the communication device 220 via an optical transmission line 161. Although FIG. 9 shows an example in which the monitoring control device 210 is connected to one communication device 220, it may be connected to a plurality of the communication devices 220.

The communication device 220 is connected to another adjacent communication device 220 via an optical transmission line 160. A user device 140 may be connected to the communication device 220. The communication device 220 relays user data. The N communication devices 220 are described as the communication devices 220-1 to 220-N, respectively. Although the communication devices 220 are connected in cascade in FIG. 9, different topologies may be used.

The communication device 220 transmits and receives network signals between the communication device 220 and the monitoring control device 210 in an out-of-band method using a wavelength different from the wavelength of light for transmitting and receiving user data to and from another communication device 220. Furthermore, the communication devices 220 may transmit and receive network signals between the communication devices 220 in an out-of-band method. As in the first embodiment, the network signal includes destination information, transmission source information and data type information.

Hereinafter, the communication device 220 connected to the monitoring control device 210 will be referred to as a communication device 220a, and the communication device 220 not connected to the monitoring control device 210 will be referred to as a communication device 220b. The monitoring control device 210 connected to the communication device 220a is referred to as the adjacent monitoring control device 210 of the communication device 220a.

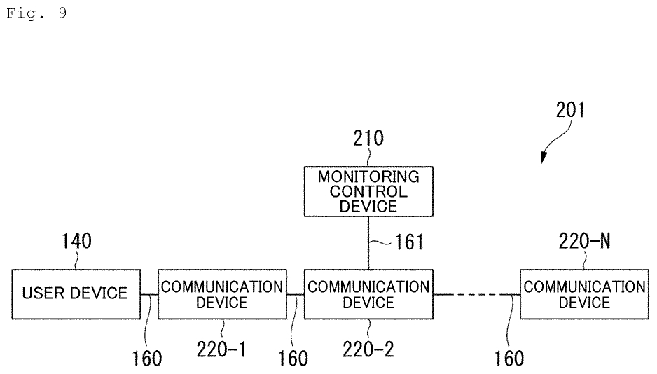

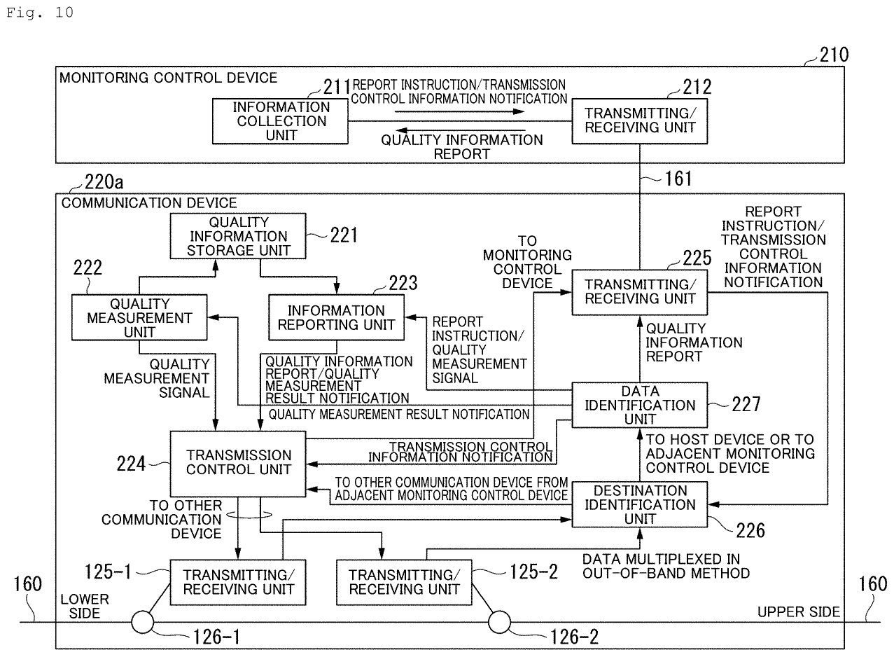

FIG. 10 is a block diagram showing a configuration example of the monitoring control device 210 and the communication device 220a. In FIG. 10, only functional blocks related to the present embodiment are extracted and shown.

The monitoring control device 210 includes an information collection unit 211 and a transmitting/receiving unit 212.

The information collection unit 211 transmits a network signal addressed to the communication device 220. The network signal transmitted by the information collection unit 211 is one of both of a report instruction and a transmission control information notification. The report instruction includes destination information indicating the destination communication device 220, transmission source information indicating the host device, and data type information indicating the report instruction. The transmission control information notification includes destination information indicating the destination communication device 220, transmission source information indicating the host device, data type information indicating the transmission control information, and transmission control information to be notified to the destination communication device 220. The transmission control information is information with which it is possible to acquire the channel and transmission timing used to transmit the out-of-band signal. The transmission control information may include routing information. In the destination information, a unicast destination using the address of the communication device 220 may be set, or a multicast or broadcast destination including the destination communication device 220 may be set. The information collection unit 211 also receives the quality information report returned in response to the report instruction.

The transmitting/receiving unit 212 is an optical transceiver (TRx). The transmitting/receiving unit 212 converts the signal output from the information collection unit 211 from an electrical signal to an optical signal, and outputs the optical signal to the optical transmission line 161. The transmitting/receiving unit 212 also converts an optical signal received from the communication device 220 via the optical transmission line 161 into an electrical signal and outputs the electrical signal to the transmitting/receiving unit 212.

In the communication device 220a shown in FIG. 10, the same parts as those of the communication device 120 of the first embodiment shown in FIG. 5 are denoted by the same reference numerals, and the description thereof will be omitted. The communication device 220a includes a quality information storage unit 221, a quality measurement unit 222, an information reporting unit 223, a transmission control unit 224, a transmitting/receiving unit 125-1, a transmitting/receiving unit 125-2, a coupler 126-1, a coupler 126-2, a transmitting/receiving unit 225, a destination identification unit 226 and a data identification unit 227.

The quality information storage unit 221 stores network quality information. The network quality information indicates network quality measurement results, The quality measurement unit 222 measures network quality and writes network quality information indicating the measurement results to the quality information storage unit 221. The quality measurement unit 222 measures network quality by transmitting quality measurement signals to other communication devices 220. The quality measurement signal includes destination information indicating another destination communication device 220, transmission source information indicating the host device, and data type information indicating the quality measurement. The quality measurement unit 222 also receives a quality measurement result notification returned from another communication device 220 in response to the quality measurement signal. The quality measurement unit 222 writes the network quality measurement result set in the received quality measurement result notification to the quality information storage unit 221.

Upon receiving a report instruction from monitoring control device 210, the information reporting unit 223 generates a quality information report. The quality information report includes destination information indicating the monitoring control device 210 that transmitted the report instruction, transmission source information indicating the host device, data type information indicating the quality information, and the network quality measurement results that the information reporting unit 223 reads from the quality information storage unit 221. The information reporting unit 223 outputs the generated quality information report to the transmission control unit 224.

Upon receiving a quality measurement signal from another communication device 220, the information reporting unit 223 generates a quality measurement result notification. The quality measurement result notification includes destination information indicating the communication device 220 which is the source of the quality measurement signal, transmission source information indicating the host device, data type information indicating the quality measurement result, and the network quality measurement results that the information reporting unit 223 reads from the quality information storage unit 221. The information reporting unit 223 outputs the generated quality measurement result notification to the transmission control unit 224. Note that the quality measurement result notification is transmitted in the direction in which the quality measurement signal was received.

The transmission control unit 224 controls the transmitting/receiving unit 125 to transmit the network signal addressed to the other communication device 220 in the out-of-band method, similarly to the transmission control unit 124 of the first embodiment. Furthermore, the transmission control unit 224 outputs the network signal addressed to the adjacent monitoring control device 210 to the transmitting/receiving unit 225 and instructs transmission.

The transmitting/receiving unit 225 is, for example, an optical transceiver (TRx). The transmitting/receiving unit 225 receives the network signal transmitted by the adjacent monitoring control device 210 from the optical transmission line 161, converts the received network signal from an optical signal to an electrical signal, and outputs the electrical signal to the destination identification unit 226. Further, the transmitting/receiving unit 225 converts a network signal addressed to the monitoring control device 210 from an electrical signal to an optical signal and outputs the optical signal to the optical transmission line 161.

The destination identification unit 226 reads the destination information set in the network signal. The destination identification unit 226 outputs the network signal to the data identification unit 227 when it determines that the destination information is addressed to the host device or an adjacent monitoring control device 210. It should be noted that the destination identification unit 226 stores in advance the information on the destination of the adjacent monitoring control device 210. The destination identification unit 226 outputs the received network signal to the transmission control unit 224 when the destination information of the network signal output from the transmitting/receiving unit 225 is not addressed to the host device. The destination identification unit 226 discards the received network signal when the destination information of the network signal output from the transmitting/receiving unit 125 is neither addressed to the host device nor to the adjacent monitoring control device 210.

The data identification unit 227 reads data type information set in the network signal. The data identification unit 227 outputs the received network signal to the information reporting unit 223 when the data type information indicates a report instruction or quality measurement. The data identification unit 227 outputs the network signal to the quality measurement unit 222 when the data type information indicates the quality measurement result. Further, the data identification unit 227 outputs the received network signal to the transmitting/receiving unit 225 when the data type information indicates quality information. Further, the data identification unit 227 outputs the network signal to the transmission control unit 224 when the data type information indicates transmission control information.

As in the first embodiment, an optical filter may be provided between the coupler 126-i and the transmitting/receiving unit 125-i. The optical filter removes signals in unwanted frequency bands. Further, the communication device 120 may use an in-line modulator instead of the coupler 126-i and the transmitting/receiving unit 125-i.

Instructions and reports between the information collection unit 211 of the monitoring control device 210 and the information reporting unit 223 of the communication device 220a may be of the Poll/Report type such as SNMP (Simple Network Management Protocol) or the Pub/Sub type such as Telemetry. In addition, transmission and reception of network signals between the monitoring control device 210 and the communication device 220a may be either an in-band method or an out-of-band method, since user data is not transmitted and received. The monitoring control device 210 and the communication device 220a may be integrated into one communication device. In that case, the integrated communication device does not have the transmitting/receiving unit 212 and the transmitting/receiving unit 225, and the information collection unit 211 may directly transmit and receive data to and from the transmission control unit 224 and the data identification unit 227.

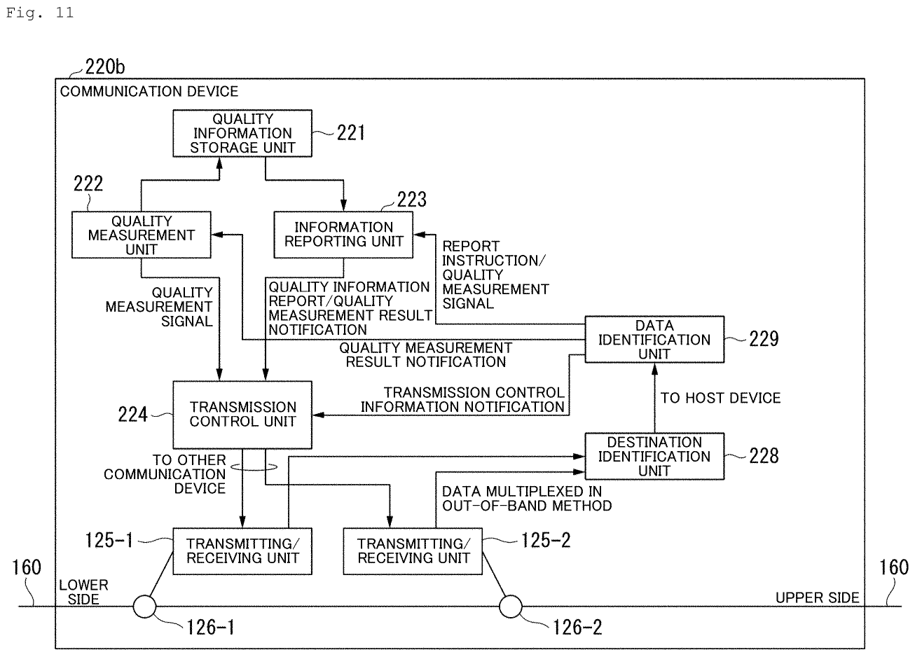

FIG. 11 is a block diagram showing a configuration example of the communication device 220b. In the communication device 220b shown in FIG. 11, the same parts as those of the communication device 220a of the first embodiment shown in FIG. 10 are denoted by the same reference numerals, and the description thereof will be omitted. The communication device 220b differs from the communication device 220a in that it does not include the transmitting/receiving unit 225, it includes the destination identification unit 228 instead of the destination identification unit 226, and includes the data identification unit 229 instead of the data identification unit 227.

The destination identification unit 228 reads destination information set in the network signal received from the transmitting/receiving unit 125. The destination identification unit 228 outputs the network signal to the data identification unit 229 when it determines that the destination information indicates the host device. If the destination identification unit 228 determines that the destination information does not indicate the host device, the destination identification unit 228 discards the received network signal.

The data identification unit 229 outputs the network signal to the information reporting unit 223 when the data type information set in the received network signal indicates a report instruction or quality measurement. The data identification unit 229 outputs the network signal to the quality measurement unit 222 when the data type information indicates the quality measurement result. Further, the data identification unit 229 outputs the network signal to the transmission control unit 224 when the data type information indicates transmission control information.

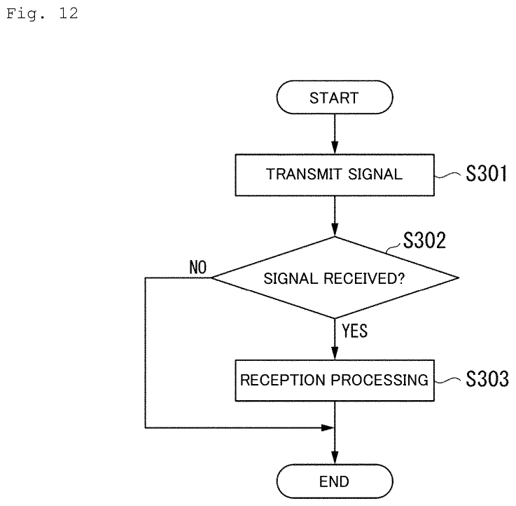

FIG. 12 is a flowchart showing network signal transmission/reception processing in the monitoring control device 210. The information collection unit 211 of the monitoring control device 210 generates a network signal that is a report instruction or transmission control information notification addressed to the communication device 220 and outputs the generated network signal to the transmitting/receiving unit 212. The transmitting/receiving unit 212 converts a network signal into an optical signal, and transmits the optical signal to the communication device 220a connected to the host device via the optical transmission line 161 (step S301). When the transmitting/receiving unit 212 receives a network signal from the communication device 220a via the optical transmission line 161 (step S302), the transmitting/receiving unit 212 converts the received network signal from an optical signal to an electrical signal and outputs the electrical signal to the information collection unit 211 (step S303). The received network signal is the quality information report returned from the communication device 220 in response to the report instruction.

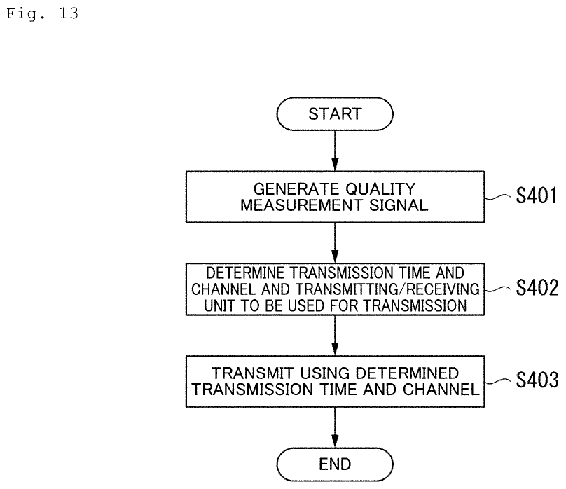

FIG. 13 is a flowchart showing network signal transmission processing in the communication device 220. The quality measurement unit 222 generates a quality measurement signal addressed to another communication device 220, and outputs the generated quality measurement signal to the transmission control unit 224 (step S401). The transmission control unit 224 determines the transmission time of the quality measurement signal, and the channel and the transmitting/receiving unit 125 to be used for transmission, as in step S102 of the first embodiment (step S402). The transmission control unit 224 outputs the quality measurement signal to the determined transmitting/receiving unit 125-i, and further instructs the determined transmission time and channel. The transmitting/receiving unit 125-i and the coupler 126-i output the quality measurement signal to the optical transmission line 160 by the same processing as in step S103 of the first embodiment (step S403).

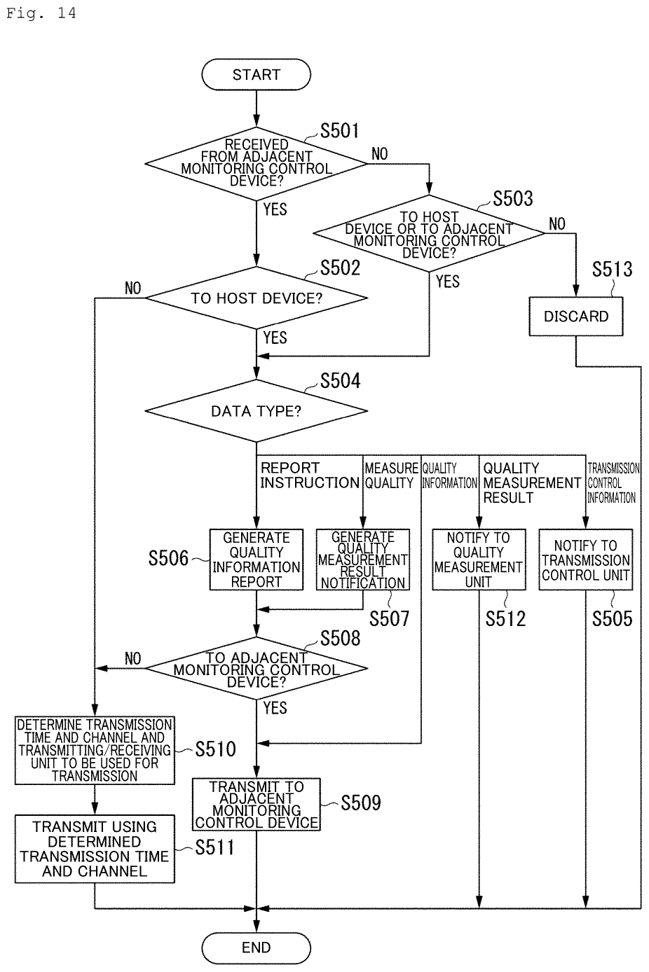

FIG. 14 is a flowchart showing network signal reception processing in the communication device 220a. The transmitting/receiving unit 225 of the communication device 220a receives the network signal transmitted in step S301 of FIG. 12 from the monitoring control device 210 (step S501: YES). The transmitting/receiving unit 225 converts the network signal into an electrical signal and outputs the electrical signal to the destination identification unit 226. The destination identification unit 226 determines whether the destination of the network signal is the host device (step S502). The destination identification unit 226 outputs the network signal to the data identification unit 227 when it determines that the destination is the host device (step S502: YES). The destination identification unit 226 outputs the network signal to the transmission control unit 224 when it determines that the destination is not the host device (step S502: NO).

On the other hand, when the transmitting/receiving unit 125 of the communication device 220a receives a network signal (step S501: NO), it converts the network signal into an electrical signal and outputs the electrical signal to the destination identification unit 226. The destination identification unit 226 outputs the received network signal to the data identification unit 227 when the destination is addressed to the host device or adjacent monitoring control device 210 (step S503: YES) .

If YES is determined at step S502, or if YES is determined at step S503, the data identification unit 227 determines the data type information set in the network signal (step S504).

When the data type information indicates transmission control information, the data identification unit 227 determines that the received network signal is the transmission control information notification from the monitoring control device 210 addressed to the host device. The data identification unit 227 outputs the transmission control information notification to the transmission control unit 224 (step S505). The transmission control unit 224 stores the transmission control information set in the received transmission control information notification.

When the data type information indicates a report instruction, the data identification unit 227 determines that the received network signal is a report instruction received from an adjacent monitoring control device 210 or a report instruction transmitted via another communication device 220 from the monitoring control device 210 not adjacent to the host device. The data identification unit 227 outputs a report instruction to the information reporting unit 223. The information reporting unit 223 reads the network quality measurement result requested by the quality measurement signal from the quality information storage unit 221. The information reporting unit 223 generates the quality information report in which destination information indicating the monitoring control device 210 as the source of the quality measurement signal, transmission source information indicating the host device, data type information indicating the quality information report, and quality information indicating the read measurement result are set (step S506). The information reporting unit 223 outputs the generated quality information report to the transmission control unit 224.

In step S504, the data identification unit 227 determines that the received network signal is a quality measurement signal transmitted from another communication device 220 when the data type information indicates quality measurement. The data identification unit 227 outputs the received quality measurement signal to the information reporting unit 223. The information reporting unit 223 reads the network quality measurement result corresponding to the quality measurement signal from the quality information storage unit 221. The information reporting unit 223 generates a quality measurement result notification in which destination information indicating the communication device 220 as the source of the quality measurement signal, transmission source information indicating the host device, data type information indicating the quality measurement result, and quality measurement result information indicating the read measurement result are set (step S507). The information reporting unit 223 outputs the generated quality measurement result notification to the transmission control unit 224.

After the processing of step S506 or step S507, the transmission control unit 224 determines whether the destination of the network signal to be transmitted is the adjacent monitoring control device 210 (step S508). The network signal to be transmitted is the quality information report generated in step S506 or the quality measurement notification generated in step S507. When the transmission control unit 224 determines that the destination is the adjacent monitoring control device 210 (step S508: YES), the transmission control unit 224 outputs the network signal to the transmitting/receiving unit 225.

The transmitting/receiving unit 225 converts the network signal to be transmitted from an electrical signal to an optical signal, and transmits the optical signal to the monitoring control device 210 via the optical transmission line 161 (step S509). The transmitting/receiving unit 212 of the monitoring control device 210 performs the processing of steps S302 and S303 in FIG. 12, converts the network signal received from the communication device 220a to an electrical signal, and outputs the electrical signal to the information collection unit 211.

If the transmission control unit 224 determines that the destination of the network signal to be transmitted is not the adjacent monitoring control device 210 of the host device (step S508: NO), or if it is determined NO in step S502, the processing of step S510 is performed. That is, the transmission control unit 224 determines the transmission time of the network signal and the channel and the transmitting/receiving unit 125 to be used for transmission by the same processing as in step S102 of FIG. 6 (step S510). When the network signal to be transmitted is the quality measurement result notification, the transmission control unit 224 may select the transmitting/receiving unit 125-i that received the quality measurement signal. The transmission control unit 224 outputs the network signal to the determined transmitting/receiving unit 125-i, and further instructs the determined transmission time and channel. The transmitting/receiving unit 125-i converts the network signal from an electrical signal to an optical signal of the wavelength used for the instructed channel by the same processing as step S103 in FIG. 6 and outputs the instructed transmission time to the coupler 126-i. The coupler 126-i couples the network signal to the optical transmission line 160 (step S511).

If the data identification unit 227 determines in step S504 that the data type information indicates quality information, the data identification unit 227 determines that the received network signal is a quality information report addressed to the adjacent monitoring control device 210 from another communication device 220. The data identification unit 227 outputs a quality information report to the transmitting/receiving unit 225. The transmitting/receiving unit 225 converts the quality information report from an electrical signal to an optical signal, and transmits the optical signal to the adjacent monitoring control device 210 via the optical transmission line 161 (step S509). The transmitting/receiving unit 212 of the monitoring control device 210 performs the processing of steps S302 and S303 in FIG. 12, converts the received network signal from an optical signal to an electrical signal, and outputs the electrical signal to the information collection unit 211.

In step S504, when the data identification unit 227 determines that the data type is the quality measurement result, the data identification unit 227 determines that the received network signal is the quality measurement result notification returned from the other communication device 220 in response to the quality measurement signal transmitted by the host device.

The data identification unit 227 outputs a quality measurement result notification to the quality measurement unit 222 (step S512). The quality measurement unit 222 acquires the network quality measurement result in the other communication devices 220 from the quality measurement result notification, and stores the acquired measurement result in the quality information storage unit 221.

In step S503, if the destination identification unit 226 determines that the destination information is not addressed to the host device or to the adjacent monitoring control device 210 but is addressed to another communication device 220 (step S503: NO), the destination identification unit 226 discards the received network signal (step S513).

In step S506, the information reporting unit 223 may instruct the quality measurement unit 222 to measure quality when a report instruction is received from the monitoring control device 210. The information reporting unit 223 reads from quality information storing unit 221 the measurement result to be set in the quality information report after the quality measurement unit 222 ends quality measurement. In addition, the quality measurement unit 222 may transmit a quality measurement signal to other communication devices 220 when quality measurement is instructed from the information reporting unit 223. The information reporting unit 223 writes the network quality measurement result into the quality information storage unit 221 based on the quality measurement result notification returned by the quality measurement unit 222, and then reads the measurement result to be set in the quality information report.

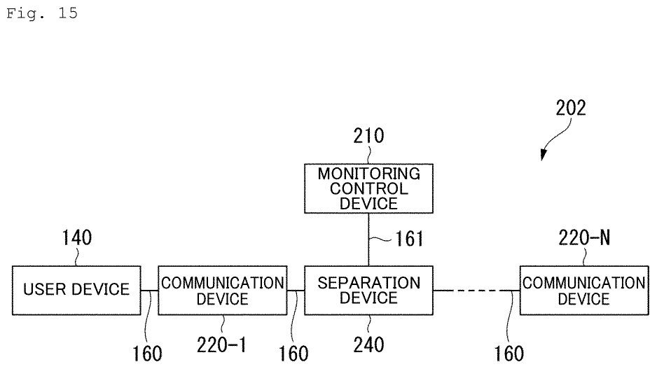

The network signal reception processing of the communication device 220b is also the same as the network signal reception processing of the communication device 220a shown in FIG. 14. However, the transmitting/receiving unit 225 of the communication device 220b always determines NO in step S501, and the transmission control unit 224 of the communication device 220b determines NO in step S508. The communication device 220b does not have the adjacent monitoring control device 210. Therefore, the communication device 220b may perform the processing of step S503 without performing the processing of steps S501 and S502, may not perform the processing of steps S508 and S509, and perform the processing from step S510 after the processing of step S506 or step S507 is performed. Further, when the destination identification unit 228 determines in step S503 that the destination information does not indicate the host device, the processing The monitoring control device 210 may be connected to a separation device as shown in FIG. 15. The separation device is a device that separates in-band user data and out-of-band network signals.

FIG. 15 is a diagram showing a configuration example of a communication system 202 according to the second embodiment. In the communication system 202 shown in FIG. 15, the same parts as those in the communication system 201 shown in FIG. 9 are denoted by the same reference numerals, and the description thereof will be omitted. The communication system 202 has a monitoring control device 210, communication devices 220-1 to 220-N, and a separation device 240. The communication devices 220-1 to 220-N in the communication system 202 are the communication device 220b shown in FIG. 11. The communication system 202 has a communication network composed of a monitoring control device 210 and communication devices 220-1 to 220-N connected in cascade. The separation device 240 is provided between two communication devices 220. The monitoring control device 210 is connected to the separation device 240 by the optical transmission line 161.

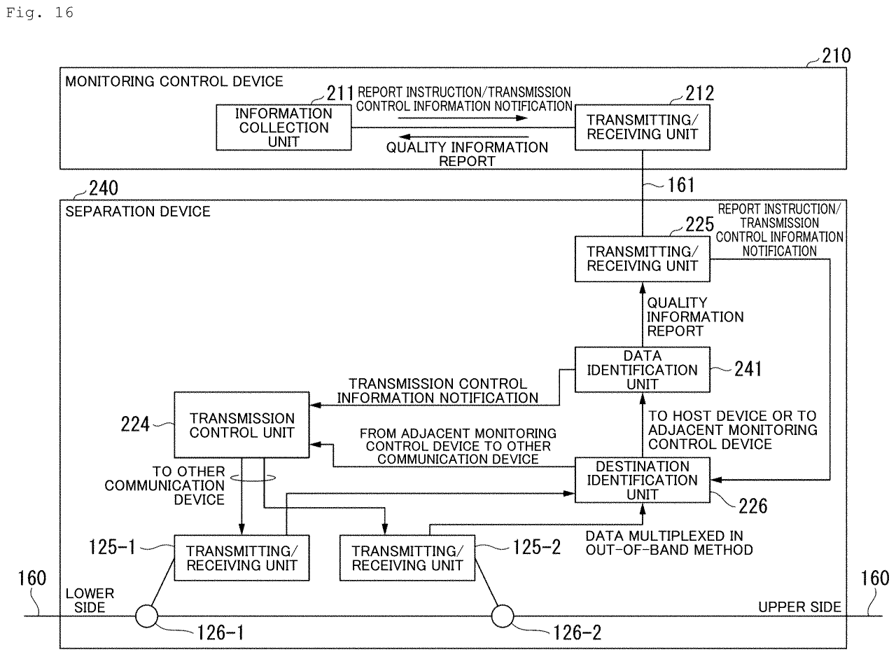

FIG. 16 is a block diagram showing a configuration example of the separation device 240. In FIG. 16, only functional blocks related to the present embodiment are extracted and shown. In the separation device 240 shown in FIG. 16, the same parts as the communication device 220a shown in FIG. 10 are denoted by the same reference numerals, and the description thereof will be omitted. The separation device 240 includes a transmission control unit 224, a transmitting/receiving unit 125-1, 8 transmitting/receiving unit 125-2, a coupler 126-1, a coupler 126-2, a transmitting/receiving unit 225, a destination identification unit 226, and a data identification unit 241.

The data identification unit 241 reads data type information set in the network signal. The data identification unit 241 outputs the received network signal to the transmission control unit 224 when the data type information indicates transmission control information. The data identification unit 241 outputs the received network signal to the transmitting/receiving unit 225 when the data type information indicates quality information.

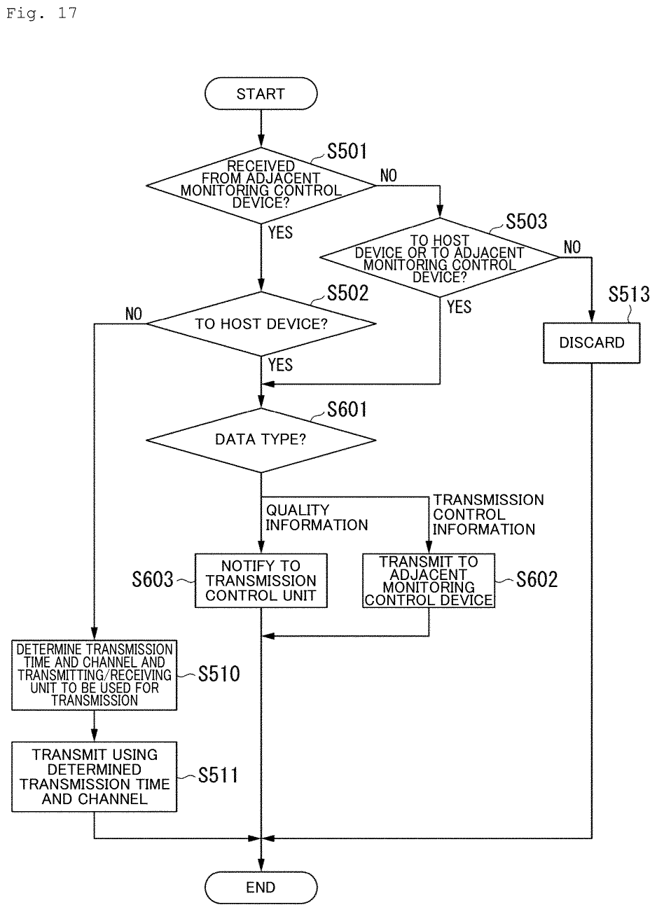

FIG. 17 is a flowchart showing network signal reception processing in the separation device 240. In the flowchart shown in FIG. 17, the same processing as in FIG. 14 is assigned the same reference numerals, and detailed description thereof will be omitted.

The transmitting/receiving unit 225 of the separation device 240 converts the network signal received from the monitoring control device 210 from an optical signal to an electrical signal, and outputs the electrical signal to the destination identification unit 226 (step S501: YES). The destination identification unit 226 outputs the network signal to the data identification unit 241 when determining that the destination is the host device (step S502: YES), and outputs the network signal to the transmission control unit 224 when determining that the destination is not the host device (step S502: NO).

Further, the transmitting/receiving unit 125 of the separation device 240 converts the received network signal into an electrical signal and outputs the electrical signal to the destination identification unit 226 (step S501: NO). If the destination identification unit 226 determines that the destination is the host device or the adjacent monitoring control device 210 that is the monitoring control device 210 connected to the host device (step S503: YES), the destination identification unit 226 outputs the network signal to the data identification unit 241.

If YES is determined in step S502, or if YES is determined in step S503, the data identification unit 241 determines the data type information set in the network signal (step S601). When the data type information indicates transmission control information, the data identification unit 241 determines that the received network signal is transmission control information notification addressed to the host device from the adjacent monitoring control device 210 or the monitoring control device 210 connected to the other separation device 240. The data identification unit 241 outputs the transmission control information notification to the transmission control unit 224 (step S602). The transmission control unit 224 stores the transmission control information set in the received transmission control information notification.

When the data identification unit 241 determines that the data type information indicates quality information, the data identification unit 241 determines that the received network signal is a quality information report from the communication device 220 addressed to adjacent monitoring control device 210. The data identification unit 241 outputs a quality information report to the transmitting/receiving unit 225. The transmitting/receiving unit 225 converts the quality information report from an electrical signal to an optical signal, and transmits the optical signal to the adjacent monitoring control device 210 via the optical transmission line 161 (step S603). The transmitting/receiving unit 212 of the monitoring control device 210 performs the processing of steps S302 and S303 in FIG. 12, converts the received quality information report from an optical signal to an electrical signal, and outputs the electrical signal to the information collection unit 211.

If NO is determined in step S502, the separation device 240 performs the same processing as in steps S103 and S104 of FIG. 6 and transmits the network signal received from the adjacent monitoring control device 210 to the optical transmission line 160 (steps S510 and S511).

In step S503, when the destination identification unit 226 determines that the destination information is neither addressed to the host device nor to the adjacent monitoring control device 210 (step S503: NO), the destination identification unit 226 discards the received network signal (step S513).

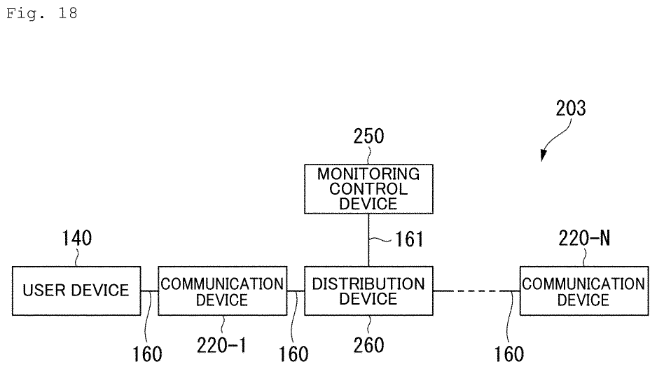

The monitoring control device may be connected to a distribution device as shown in FIG. 18. The distribution device is a device that copies, both in-band and out-of-band signals that are transmitted through the network.

FIG. 18 is a diagram showing a configuration example of a communication system 203. In the communication system 203 shown in FIG. 18, the same parts as those in the communication system 202 shown in FIG. 15 are denoted by the same reference numerals, and the description thereof will be omitted. The communication system 203 has a monitoring control device 250, communication devices 220-1 to 220-N, and a distribution device 260. The communication devices 220-1 to 220-N in the communication system 203 are the communication device 220b shown in FIG. 11. The distribution device 260 is provided between two communication devices 220. The monitoring control device 250 is connected to the distribution device 260 by the optical transmission line 161.

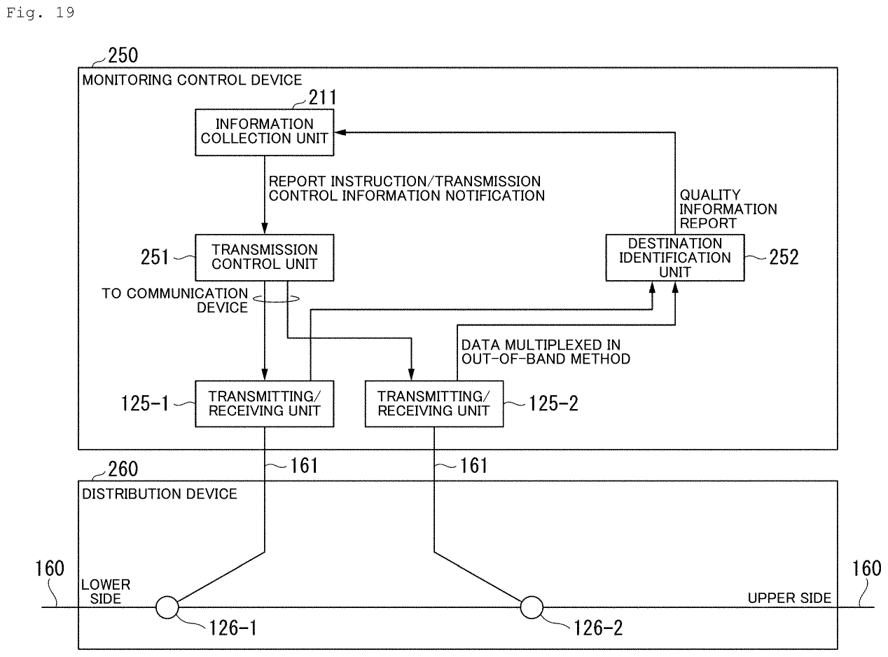

FIG. 19 is a block diagram showing a configuration example of the monitoring control device 250 and the distribution device 260. In FIG. 19, only functional blocks related to the present embodiment are extracted and shown. In the monitoring control device 250 and the distribution device 260 shown in FIG. 19, the same parts as those of the monitoring control device 210 and the communication device 220a shown in FIG. 10 are denoted by the same reference numerals, and the description thereof will be omitted.

The monitoring control device 250 has an information collection unit 211, a transmission control unit 251, a destination identification unit 252, a transmitting/receiving unit 125-1, and a transmitting/receiving unit 125-2. The transmission control unit 251 controls the transmitting/receiving unit 125 to transmit network signals such as the report instruction and the transmission control information notification output by the information collection unit 211 to the destination communication device 220 in an out-of-band method. The transmission control unit 251, like the transmission control unit 224 of the communication device 220, determines the transmission timing and frequency when transmitting the network signal in the out-of-band method, and instructs the transmitting/receiving unit 125. The destination identification unit 252 outputs the network signal to the information collection unit 211 when the destination information set in the received network signal indicates the host device and discards the received network signal when the destination information is not the host device.

The distribution device 260 includes a coupler 126-1 and a coupler 126-2. An optical filter that removes signals in unwanted frequency bands may be provided between the coupler 126-i of the distribution device 260 and the transmitting/receiving unit 125-i of the monitoring control device 250. Further, the distribution device 260 may use an in-line modulator instead of the coupler 126-i and the transmitting/receiving unit 125-i to perform multiplexing in the out-of-band method.

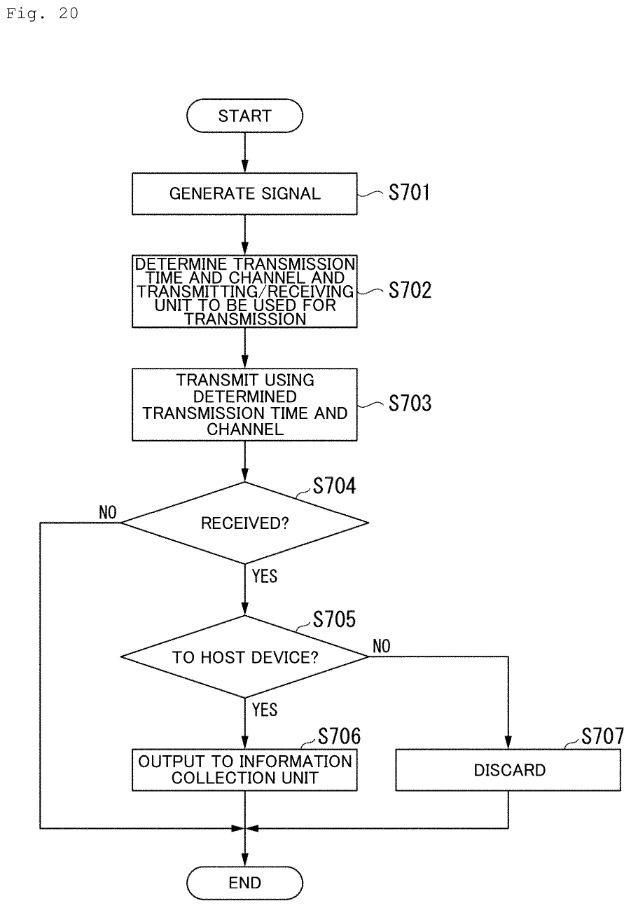

FIG. 20 is a flowchart showing network signal transmission/reception processing in the monitoring control device 250. The information collection unit 211 of the monitoring control device 250 generates a network signal, which is a report instruction or transmission control information notification addressed to the communication device 220, and outputs the generated network signal to the transmission control unit 251 (step S701).

The transmission control unit 251 performs the same processing as in step S102 of FIG. 6, and determines the transmission time of the network signal and the channel and the transmitting/receiving unit 125 to be used for transmission (step S702). The transmission control unit 251 outputs the network signal to the transmitting/receiving unit 125-i used for transmission, and further instructs the determined transmission time and channel.

The transmitting/receiving unit 125-i converts the network signal from an electrical signal to an optical signal of the wavelength used for the instructed channel. The transmitting/receiving unit 125-i outputs the information measurement signal converted into an optical signal to the coupler 126-i of the distribution device 260 at the instructed transmission time. The coupler 126-i couples the information measurement signal output from the transmitting/receiving unit 125-i of the monitoring control device 250 to the optical transmission line 160 (step S703).

The coupler 126-1 and the coupler 126-2 of the distribution device 260 split the optical signal transmitted through the optical transmission line 160. The coupler 126-i outputs the split optical signal to the transmitting/receiving unit 125-i of the monitoring control device 250. The transmitting/receiving unit 125-i receives the optical signal split by the coupler 126-i. The transmitting/receiving unit 125-i separates the network signal transmitted in the out-of-band method from the optical signal and converts it into an electrical signal. When the network signal is not obtained in the transmitting/receiving unit 125-i (step S704: NO), the monitoring control device 250 ends the processing of FIG. 20. When the network signal is obtained (step S704: YES), the transmitting/receiving unit 125-i outputs the network signal converted into the electrical signal to the destination identification unit 252.

The destination identification unit 252 reads destination information set in the network signal. The destination identification unit 252 determines whether the destination information indicates the host device (step S705). If the destination information indicates the host device, the network signal is a quality information report. When the destination identification unit 252 determines that the signal is addressed to the host device (step S705: YES), the destination identification unit 252 outputs the received network signal to the information collection unit 211 (step S706). If the destination identification unit 252 determines that the signal is not addressed to the host device (step S705: NO), the destination identification unit 252 discards the received network signal (step S707).

According to the present embodiment, since the communication system transmits and receives report instructions and quality measurements in an out-of-band method, quality measurements and quality reports are possible even when in-band communication is not established.

### Third Embodiment

In the third embodiment, the monitoring control device employs the second embodiment, collects quality information before establishing a main signal connection, and determines a communication path to be used for the main signal based on the collected quality information.

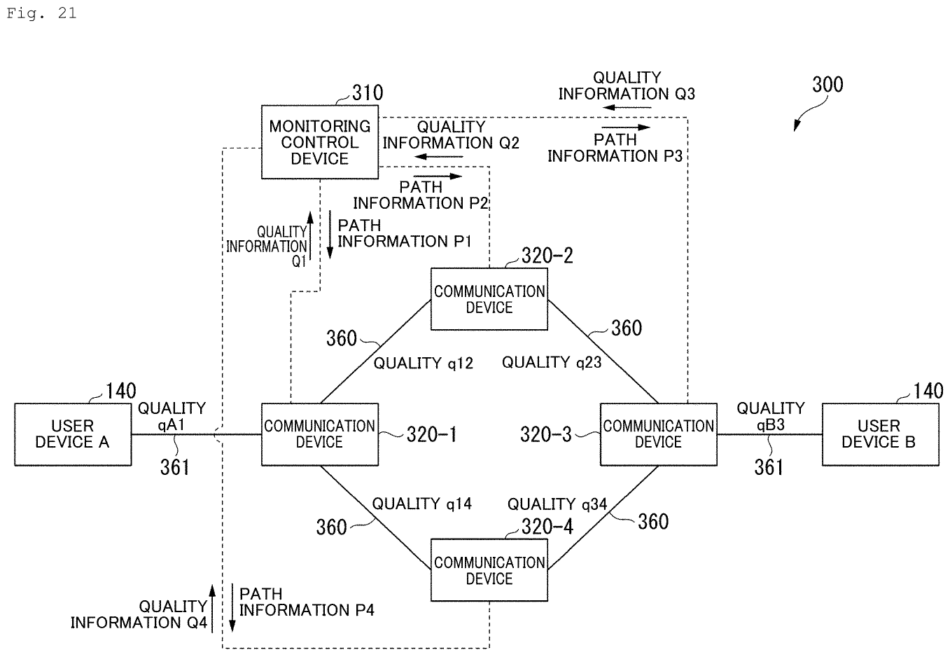

FIG. 21 is a diagram showing the configuration of a communication system 300. The communication system 300 has a monitoring control device 310 and four communication devices 320 connected in a ring. The communication device 320 is connected to another adjacent communication device 320 via an optical transmission line 360. The four communication devices 320 are described as the communication devices 320-1 to 320-4, respectively. The monitoring control device 310 is connected to some of the communication devices 320-1 to 320-N via optical transmission lines. The monitoring control device 310 has the functions of the monitoring control device 210 in the second embodiment. The communication device 320 connected to the monitoring control device 310 has the function of the communication device 220a in the second embodiment, and the communication device 320 not connected to the monitoring control device 310 has the function of the communication device 220b in the second embodiment.

Alternatively, the monitoring control device 310 is connected to the separation device 240 or the distribution device 260 (not shown) provided on the optical transmission line 360. When the monitoring control device 310 is connected to the separation device 240, the monitoring control device 310 has the functions of the monitoring control device 210 in the second embodiment, and the communication device 320 has the functions of the communication device 220b in the second embodiment. When the monitoring control device 310 is connected to the distribution device 260, the monitoring control device 310 has the functions of the monitoring control device 250 in the second embodiment, and the communication device 320 has the function of the communication device 220b in the second embodiment.

The communication device 320-1 and the communication device 320-3 are connected to the user device 140 by an optical transmission line 361. The user device 140 connected to the communication device 320-1 is referred to as a user device A, and the user device 140 connected to the communication device 320-3 is referred to as a user device B.

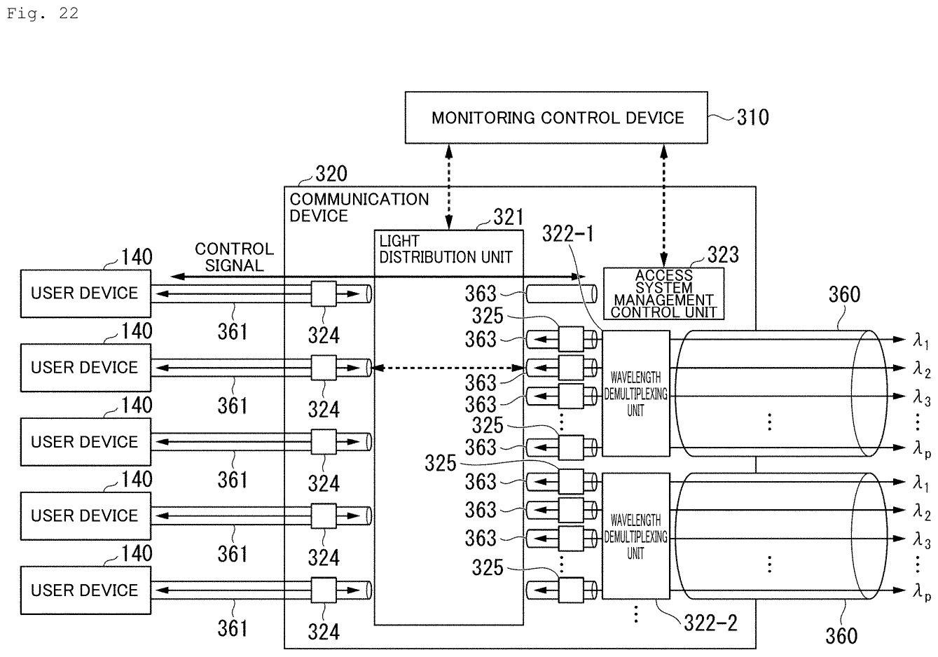

FIG. 22 is a diagram showing the configuration of the optical switch function of the communication device 320. The communication device 320 has an optical splitter 321, a wavelength demultiplexing unit 322, an access system management control unit 323, an amplifier 324 and an amplifier 325. The two wavelength demultiplexing units 322 included in the communication device 320 are respectively referred to as a wavelength demultiplexing unit 322-1 and a wavelength demultiplexing unit 322-2.

The optical splitter 321 has a plurality of input/output ports (not shown). The optical splitter 321 outputs an optical signal input from one input/output port from another input/output port. The connection relationship between the input/output ports can be changed by instructions from the monitoring control device 310. Some input/output ports of the optical splitter 321 are connected to the user device 140 via the optical transmission line 361. Some other input/output ports of the optical splitter 321 are connected to the wavelength demultiplexing unit 322-1 via an optical transmission line 363, and some other input/output ports are connected to the wavelength demultiplexing unit 322-2 via the optical transmission line 363. One input/output port is connected to the access system management control unit 323 via the optical transmission line 363.

The wavelength demultiplexing unit 322 has multiple first ports (not shown) and one second port (not shown). The multiple first ports correspond to different wavelengths. The first ports of the wavelength demultiplexing unit 322 are connected to the input/output ports corresponding to different wavelengths λ₁ to λₚ (p is an integer of 2 or more) of the optical splitter 321 via the optical transmission line 363, respectively. The second port of the wavelength demultiplexing unit 322 is connected to another communication device 320 via the optical transmission line 360. The wavelength demultiplexing unit 322 multiplexes light of different wavelengths input from the first port and outputs the multiplexed light from the second port. The wavelength demultiplexing unit 322 demultiplexes the wavelength-multiplexed light input from the second port according to the wavelength, and outputs the demultiplexed light from the second port according to the wavelength. In the case of the communication device 320-1, the second port of the wavelength demultiplexing unit 322-1 is connected to the optical transmission line 360 between the communication device 320-1 and the communication device 320-2, and the second port of the wavelength demultiplexing unit 322-2 is connected to the optical transmission line 360 between the communication device 320-1 and the communication device 320-4.

The amplifier 324 is provided on the optical transmission line 361 and the amplifier 325 is provided on the optical transmission line 363. The amplifier 324 and the amplifier 325 are, for example, variable attenuators (ATT). The amplifier 324 amplifies the light transmitted through the optical transmission line 361. The amplifier 325 amplifies the light transmitted through the optical transmission line 363.

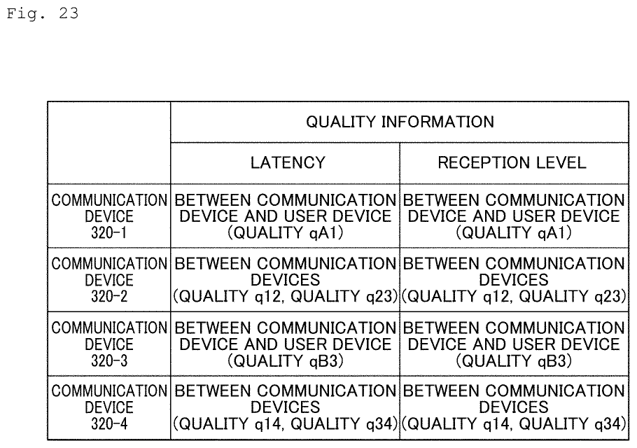

FIG. 23 is a diagram showing an example of quality information. The quality information indicates latency and reception level measured at each communication device 320. The communication device 320-1 measures the latency and reception level between the communication device 320-1 and the user device A as quality qA1. The communication device 320-2 measures the latency and reception level between the communication device 320-2 and the communication device 320-1 as quality q12, and measures the latency and reception level between the communication device 320-2 and the communication device 320-3 as quality q23. The communication device 320-3 measures the latency and reception level between the communication device 320-3 and the user device B as quality qB3. The communication device 320-4 measures the latency and reception level between the communication device 320-4 and the communication device 320-1 as quality q14, and measures the latency and reception level between the communication device 320-4 and the communication device 320-3 as quality q34. Note that the quality information measured by the communication device 320 may include band information such as a communication band, a switching band, and a processing band for computing.

Next, the operation of the communication system 300 shown in FIG. 21 will be described. The communication system 300 performs an initial connection procedure described in Reference 2 “Shin Kaneko, Kazutaka Hara, Jun-ichi Kani, Takeshi Seki, Hiroki Kawahara, Takashi Miyamura, and Hideki Maeda, “Novel System Architecture toward the Realization of All-photonics Network”, Journal of the Institute of Electronics, Information and Communication Engineers, Vol. 104, No. 4, Fug. 4, 2021, page 474”. In this initial setting procedure, the monitoring control device 310 of the communication system 300 collects quality information from each communication device 320 using the AMCC triggered by the device information report. The monitoring control device 310 determines a communication path between the user device A and the user device B using the collected quality information. Note that the communication system 300 may collect quality information before reporting device information. For example, the communication system 300 may collect quality information upon triggering from the monitoring control device 310. The monitoring control device 310 sets the determined communication path in the communication device 320 as an optical route setting. A description will be given below of the features of the present embodiment.

First, the user device A transmits a new connection request. For example, the new connection request requests communication between the user device A and the user device B. The optical splitter 321 of the communication device 320-1 outputs the new connection request transmitted by the user device A to the access system management control unit 323. The access system management control unit 323 outputs the received new connection request to the monitoring control device 310.

Upon receiving a new connection request, the monitoring control device 310 transmits an AMCC signal report instruction to each communication device 320 in order to select an appropriate communication path that satisfies the end-to-end service request. The communication device 320-1 transmits quality information Q1 set to quality qA1 to the monitoring control device 310 as a quality information report. The communication device 320-2 transmits quality information Q2 set to quality q12 and quality q23 to the monitoring control device 310 as a quality information report. The communication device 320-3 transmits quality information Q3 set to quality qB3 to the monitoring control device 310 as a quality information report. The communication device 320-4 transmits quality information Q4 set to quality q14 and quality q34 to the monitoring control device 310 as a quality information report.

Based on the pieces of quality information Q1 to Q4 reported by the quality information reports transmitted by each communication device 320, the monitoring control device 310 calculates the quality information between the communication devices 320, between the user device A and the communication device 320-1, and between the user device B and the communication device 320-3. The monitoring control device 310 selects an appropriate end-to-end communication path based on the quality information calculation result. The monitoring control device 310 generates path information for transmitting user data through the selected communication path. The monitoring control device 310 transmits, to the communication device 320-n, a transmission control information notification in which the path information Pn in the communication device 320-n is set. Alternatively, the monitoring control device 310 may transmit, by multicasting or broadcasting, the transmission control information notification in which the path information of all the communication devices 320 is set. The optical splitter 321 of each communication device 320 routes an optical signal in which user data is set between the user device A and the user device B according to the path information Pn set in the transmission control information notification.

When selecting an appropriate communication path as described above, the monitoring control device 310 determines whether the end-to-end quality for each possible combination of communication paths satisfies the service requirements and the like based on the latency indicated by the pieces of quality information Q1 to Q4 received from each communication device 320. In the case of FIG. 21, there are two communication paths, a first communication path passing through the user device A, the communication device 320-1, the communication device 320-2, the communication device 320-3, and the user device B in this order and a second communication path passing through the user device A, the communication device 320-1, the communication device 320-4, the communication device 320-3, and the user device B in that order. The monitoring control device 310 determines whether the end-to-end quality satisfies service requirements and the like for each of the first communication path and the second communication path.

For example, it is assumed that the latency in the service requirements is within 100 msec (milliseconds). When the latency of the first communication path is 80 msec and the latency of the second communication path is 150 msec, the monitoring control device 310 selects the first communication path as an appropriate communication path. For example, the latency of the second communication path may be 100 msec, and both the first communication path and the second communication path may satisfy the service requirements. In this case, the monitoring control device 210 selects one of them according to a predetermined policy, such as selecting the one with higher quality.

The monitoring control device 310 also adjusts the amplifiers 324 and 325 in each communication device 320 so as to satisfy the system requirements. For example, the monitoring control device 310 determines whether the reception input level of the optical signal is within the range of an allowable reception input level based on the reception levels indicated by the pieces of received quality information Q1 to Q4. If the upper limit of the allowable reception input level is exceeded, the monitoring control device 310 adjusts the amplifiers 324 and 325 in the communication device 320 so that the reception input level of the optical signal falls within the range of the allowable reception input level. Conversely, when the received input level of the optical signal falls below the lower limit of the allowable reception input level, the monitoring control device 310 adjusts the amplifiers 324 and 325 in the communication device 320 so that the level falls within the range of the allowable reception input level.

Once the communication path is set, the communication path may be fixed without being changed. The monitoring control device 310 may periodically measure and learn the quality information using the network signal during system operation. This allows the monitoring control device 310 to dynamically change the communication path to a higher quality communication path. For example, when a plurality of communication paths are accommodated in the same communication device 320, if there is some tendency in the change of quality information due to temporal fluctuations, an appropriate communication path can be dynamically selected by taking temporal fluctuations into consideration. However, the monitoring control device 310 changes the communication path at a timing when communication of the main signal does not occur.

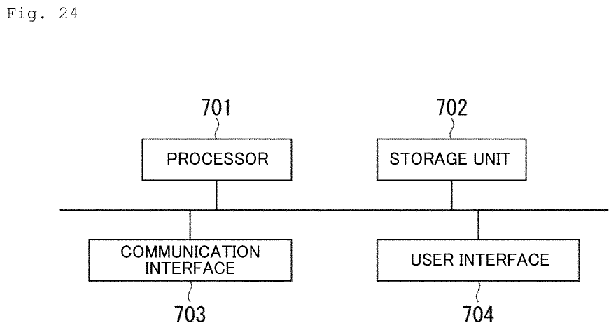

A hardware configuration example of the communication device 120 will be described. FIG. 24 is a device configuration diagram showing a hardware configuration example of the communication device 120. The communication device 120 includes a processor 701, a storage unit 702, a communication interface 703, and a user interface 704.

The processor 701 is a central processing unit that performs an operation or control. The processor 701 is a central processing unit (CPU), for example. The storage unit 702 is a storage device such as various memories and hard disks. The information measurement unit 122, the measurement response unit 123, the transmission control unit 124, the destination identification unit 127, and the data identification unit 128 are implemented by the processor 701 reading and executing a program from the storage unit 702. Some of the functions of the information measurement unit 122, the measurement response unit 123, the transmission control unit 124, the destination identification unit 127, and the data identification unit 128 may be implemented using hardware such as Application Specific Integrated Circuit (ASIC), Programmable Logic Device (PLD), Field Programmable Gate Array (FPGA). The storage unit 702 has a work area and the like used when the processor 701 performs various programs. The communication interface 703 is used to communicatively connect to other devices. The communication interface 703 corresponds to the transmitting/receiving unit 125 and the coupler 126. The user interface 704 is an input device such as a keyboard, a pointing device (mouse, tablet, or the like), buttons, or a touch panel, or a display device such as a display. An artificial operation is input by the user interface 704.

The hardware configuration of the communication device 220a is also the same as in FIG. 24. The processor 701 reads and executes the program from the storage unit 702 to implement the quality measurement unit 222, the information reporting unit 223, the transmission control unit 224, the destination identification unit 226, and the data identification unit 227. The communication interface 703 corresponds to the transmitting/receiving unit 125, the coupler 126, and the transmitting/receiving unit 225.

The hardware configuration of the communication device 220b is also the same as in FIG. 24. The processor 701 reads and executes the program from the storage unit 702 to implement the quality measurement unit 222, the information reporting unit 223, the transmission control unit 224, the destination identification unit 228, and the data identification unit 229. The communication interface 703 corresponds to the transmitting/receiving unit 125 and the coupler 126.

The hardware configuration of the monitoring control device 210 is also the same as in FIG. 24. The information collection unit 211 is implemented by the processor 701 reading the program from the storage unit 702 and executing the program. The communication interface 703 corresponds to the transmitting/receiving unit 212.

The hardware configuration of the monitoring control device 250 is also the same as in FIG. 24. The information collection unit 211, the transmission control unit 251, and the destination identification unit 252 are implemented by the processor 701 reading the program from the storage unit 702 and executing the program. The communication interface 703 corresponds to the transmitting/receiving unit 125.

The hardware configuration of the separation device 240 is also the same as in FIG. 24. The transmission control unit 224, the destination identification unit 226, and the data identification unit 241 are implemented by the processor 701 reading the program from the storage unit 702 and executing the program. The communication interface 703 corresponds to the transmitting/receiving unit 125, the coupler 126, and the transmitting/receiving unit 225.

According to the above-described embodiments, the communication system can transmit and receive information between network devices while reducing the impact on the quality of user data regardless of user data protocols.

According to the embodiments described above, the communication network that transmits user data includes a plurality of network devices. The network device has an acquisition unit, an identification unit, and a transmitting unit. For example, the network device corresponds to the communication device 120 and the monitoring control device 250 of the embodiment, the acquisition unit and the transmitting unit correspond to the transmitting/receiving unit 125 of the embodiment, and the identification unit corresponds to the destination identification unit 127 or 252 of the embodiment. The acquisition unit acquires inter-network-device data which is data superimposed on user data in an out-of-band method and exchanged between network devices included in the communication network from data obtained by splitting or copying data transmitted through a transmission line of the communication network. The identification unit outputs the acquired data to a processing unit that performs predetermined processing when a destination of the acquired data which is the inter-network-device data acquired by the acquisition unit is a host device and discards the acquired data when the destination is not the host device. The transmitting unit superimposes inter-network-device data addressed from the host device to another network device on user data transmitted through the transmission line in an out-of-band method.

The network device may further include a receiving unit that receives inter-network-device data transmitted by an adjacent network device that is connected to the host device and is another network device that does not transmit user data. For example, the network device corresponds to the communication device 220a of the embodiment, the receiving unit corresponds to the transmitting/receiving unit 225 of the embodiment, and the adjacent network device corresponds to the monitoring control device 210. The identification unit outputs the inter-network-device data received by the receiving unit to the processing unit that performs predetermined processing when a destination of the inter-network-device data received by the receiving unit is the host device. The transmitting unit superimposes the inter-network-device data received by the receiving unit on user data transmitted through the transmission line in an out-of-band method when the destination of the inter-network-device data received by the receiving unit is another network device.

The identification unit determines whether the destination of the acquired data is the adjacent network device and discards the acquired data if the destination of the acquired data is neither the adjacent network device nor the host device. The transmitting unit outputs the acquired data to the adjacent network device when the destination of the acquired data is the adjacent network device.

The transmitting unit may superimpose the inter-network-device data on user data transmitted through the transmission line in an out-of-band method using a transmission timing or frequency different from that of other inter-network-device data. The transmission line may transmit an optical signal.

Although the embodiment of the present invention has been described in detail with reference to the drawings, a specific configuration is not limited to the present embodiment, and design within the scope of the gist of the present invention, and the like are included.

### REFERENCE SIGNS LIST

101, 102 Communication system
120, 120-1 to 120-N, 180-1 to 180-N Communication device
121 Information storage unit
122 Information measurement unit
123 Measurement response unit
124 Transmission control unit
125-1, 125-2 Transmitting/receiving unit
126-1, 126-2 Coupler
127 Destination identification unit
128 Data identification unit
140 User device
160, 161 Optical transmission line
190-1, 190-2 Control device
201, 202, 203 Communication system
210 Monitoring control device
211 Information collection unit
212 Transmitting/receiving unit
220-1 to 220-N, 220a, 220b Communication device
221 Quality information storage unit
222 Quality Measurement Unit
223 Information reporting unit
224 Transmission control unit
225 Transmitting/receiving unit
226, 228 Destination identification unit
227, 229 Data identification unit
240 Separation device
241 Data identification unit
250 Monitoring control device
251 Transmission control unit
252 Destination identification unit
260 Distribution device
300 Communication system
310 Monitoring control device
320-1 to 320-4 Communication device
321 Optical splitter
322-1, 322-2 Wavelength demultiplexing unit
323 Access system management control unit
324, 325 Amplifier
360, 361, 363 Optical transmission line
701 Processor
702 Storage unit
703 Communication interface
704 User interface

1. A network device of a communication network that transmits user data, the network device comprising:
a processor; and
a storage medium having computer program instructions stored thereon, when executed by the processor, perform to:
acquires inter-network-device data which is data superimposed on user data in an out-of-band method and exchanged between network devices included in the communication network from data obtained by splitting or copying data transmitted through a transmission line of the communication network;
outputs the acquired data to a processing unit that performs predetermined processing when a destination of the acquired data which is the inter-network-device data a host device and discards the acquired data when the destination is not the host device; and
superimposes inter-network-device data addressed from the host device to another network device on user data transmitted through the transmission line in an out-of-band method.

2. The network device according to claim 1, wherein the network device is a communication device that transmits user data transmitted through the transmission line, or a monitoring control device that monitors or controls the communication network.

3. The network device according to claim 1, wherein the computer program instructions further perform to
receives inter-network-device data transmitted by an adjacent network device that is connected to the host device and is another network device that does not transmit user data,
the identification unit outputs the inter-network-device data when a destination of the inter-network-device data is the host device, and superimposes the inter-network-device data on user data transmitted through the transmission line in an out-of-band method when the destination of the inter-network-device data is another network device.

4. The network device according to claim 3, wherein the computer program instructions further perform to determines whether the destination of the acquired data is the adjacent network device and discards the acquired data if the destination of the acquired data is neither the adjacent network device nor the host device, and
outputs the acquired data to the adjacent network device when the destination of the acquired data is the adjacent network device.

5. The network device according to claim 3, wherein
the host device is a communication device that transmits user data transmitted through the transmission line, and
the adjacent network device is a monitoring control device that monitors or controls the communication network.

6. The network device according to claim 1, wherein the computer program instructions further perform to superimposes the inter-network-device data on user data transmitted through the transmission line in an out-of-band method using a transmission timing or frequency different from that of other inter-network-device data.

7. The network device according to claim 1, wherein the transmission line transmits an optical signal.

8. A data exchange method performed by a network device of a communication network that transmits user data, the method comprising:
an acquisition step of acquiring inter-network-device data which is data superimposed on user data in an out-of-band method and exchanged between network devices included in the communication network from data obtained by splitting or copying data transmitted through a transmission line of the communication network;
an identification step of outputting the acquired data to a processing unit that performs predetermined processing when a destination of the acquired data which is the inter-network-device data acquired in the acquisition step is a host device and discarding the acquired data when the destination is not the host device; and
a transmitting unit of superimposing inter-network-device data addressed from the host device to another network device on user data transmitted through the transmission line in an out-of-band method.
